(19) United States
(12) Patent Application Publication
(10) Pub. No.: US 2025/0289395 A1
(43) Pub. Date: Sep. 18, 2025

(54) WIRELESS COMMUNICATION DEVICE

(71) Applicant: Panasonic Automotive Systems Co., Ltd., Kanagawa (JP)

(72) Inventors: Shinya OTA, Kanagawa (JP); Shigetomo TAMOI, Kanagawa (JP); Akifumi KOMORI, Tokyo (JP)

(21) Appl. No.: 19/073,999

(22) Filed: Mar. 7, 2025

(30) Foreign Application Priority Data
Mar. 15, 2024 (JP) 2024- 041446

(51) Int. Cl. B60R 25/24; B60R 25/40; B62H 5/20

(52) U.S. Cl. CPC B60R 25/245; B62H 5/20; B60R 25/40

(57) ABSTRACT

A wireless communication device capable of performing wireless communication with an electronic key of a vehicle includes a rectangular substrate, a first antenna disposed at a position along a first side of the substrate at a predetermined distance away from one vertex of the substrate and extending along the first side, a second antenna disposed at a position along a second side of the substrate, which is different from the first side of the substrate, at a predetermined distance away from the vertex of the substrate and extending along the second side; and a first GND disposed near the vertex of the substrate.

### TECHNICAL FIELD

The present disclosure relates to a wireless communication device.

### BACKGROUND ART

In a case where only one antenna is used for wireless communication, there are frequencies and angles at which wireless communication performance deteriorates due to the characteristics (frequency band and directivity) of the antenna. Patent Literature 1 discloses that in a shark antenna mounted on a vehicle, two antennas having different frequency characteristics are arranged on both sides of a substrate to complement the frequency characteristics.

### CITATION LIST

### Patent Literature

Patent Literature 1: JP2016-504799A

### SUMMARY OF INVENTION

A technique is known in which a wireless communication device mounted on a vehicle receives an instruction by wireless communication from an electronic key of the vehicle and controls an operation of the vehicle. By equipping a wireless communication device with two antennas, deterioration of communication quality can be suppressed as disclosed in Patent Literature 1. In this regard, there is a demand for miniaturization of the wireless communication device equipped with two antennas.

It is an object of the present disclosure to reduce the size of a wireless communication device which is equipped with at least two antennas and to be mounted on a vehicle.

The present disclosure provides a wireless communication device that is mounted on a vehicle to perform wireless communication with an electronic key of the vehicle. The wireless communication device includes a substrate having a rectangular shape in a plan view; a first antenna disposed at a position along a first side of the substrate at a predetermined distance from one vertex of the substrate and extending along the first side; a second antenna disposed at a position along a second side of the substrate, which is different from the first side of the substrate, at a predetermined distance away from the vertex of the substrate and extending along the second side; and a first GND disposed near the vertex of the substrate.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, it is possible to reduce the size of a wireless communication device which is equipped with at least two antennas and to be mounted on a vehicle.

### BRIEF DESCRIPTION OF DRAWINGS

FIG. 1 is a schematic diagram showing a vehicle and an electronic key according to a first embodiment;

FIG. 2 is a block diagram showing configuration examples of an ECU and the electronic key according to the first embodiment;

FIG. 3 is a flowchart showing an example of a method for measuring a distance between the ECU and the electronic key according to the first embodiment;

FIG. 4 is a perspective view showing a configuration example of a substrate of the ECU according to the first embodiment;

FIG. 5 is a graph showing an example of antenna directivity of an antenna 21A and an antenna 21B according to the first embodiment;

FIG. 6 is a perspective view showing a configuration example of a first layer of the substrate of the ECU according to a second embodiment;

FIG. 7 is a plan view showing a configuration example of the first layer (L1 layer) of the substrate of the ECU according to the second embodiment;

FIG. 8 is a plan view showing a configuration example of a second layer (L2 layer) of the substrate of the ECU according to the second embodiment;

FIG. 9 is a plan view showing a configuration example of a third layer (L3 layer) of the substrate of the ECU according to the second embodiment;

FIG. 10 is a plan view showing a configuration example of a fourth layer (L4 layer) of the substrate 50 of the ECU according to the second embodiment; and

FIG. 11 is a graph showing an example of antenna directivity of the antenna 21A and the antenna 21B according to the second embodiment.

### DESCRIPTION OF EMBODIMENTS

Hereinafter, embodiments of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, and are not intended to limit the subject matter described in claims.

### First Embodiment

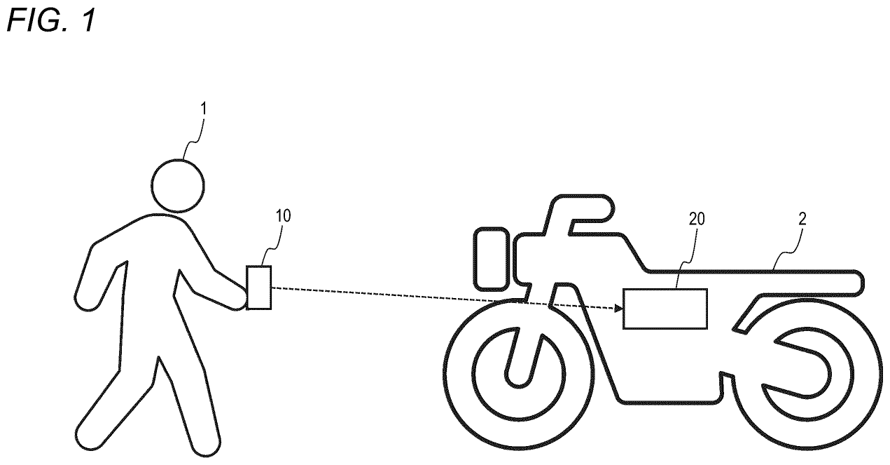

FIG. 1 is a schematic diagram showing a vehicle 2 according to a first embodiment and an electronic key 10.

An ECU 20 mounted on the vehicle 2 and the electronic key 10 carried by a user 1 of the vehicle 2 can perform wireless communication. When the user 1 of the vehicle 2 approaches the vehicle 2 while carrying the electronic key 10 of the vehicle 2, distance measurement is performed between the ECU 20 and the electronic key 10 (FOB key) using a phase difference and the radio wave intensity (RSSI) of radio waves. When it is determined that the distance is within a predetermined distance, if the vehicle 2 is a motorcycle, the user 1 turns a knob of the vehicle 2 to unlock a handlebar lock and turn on the ignition, and then press an engine start switch to start the engine. When it is determined that the distance is within a predetermined distance, if the vehicle 2 is a four-wheeled vehicle, the user 1 may touch a door handle of the vehicle 2 to unlock the door, turn a start-stop switch or a knob, unlock a handlebar lock, turn on the ignition, and start the engine. The ECU is an abbreviation for electronic control unit.

The ECU 20 measures the distance to the electronic key 10 using a wireless signal (radio wave). In the first embodiment, a configuration and method for measuring the distance between an ECU 20 and the electronic key 10 with high accuracy using a wireless signal will be described. In the first embodiment, an example in which the vehicle 2 is a motorcycle (bike) will be described. However, the vehicle 2 is not limited to a motorcycle, and may be, for example, a four-wheeled vehicle such as a car or a truck, or a special vehicle such as a forklift or a backhoe. The electronic key may be read as a FOB key.

### <Block Configuration>

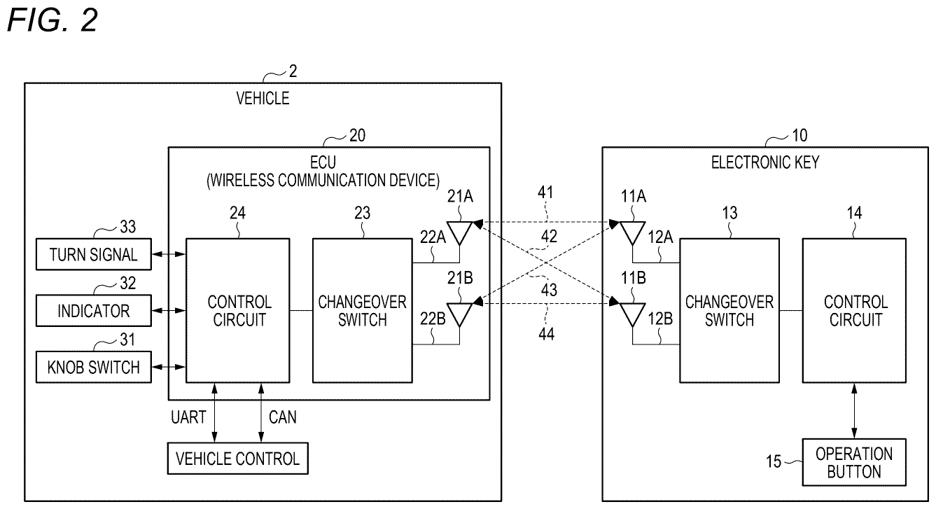

FIG. 2 is a block diagram showing configuration examples of the ECU 20 and the electronic key 10 according to the first embodiment.

The ECU 20 includes an antenna 21A, an antenna 21B, a power feeding line 22A, a power feeding line 22B, a changeover switch 23, and a control circuit 24. The antenna 21A, the antenna 21B, the power feeding line 22A, the power feeding line 22B, the changeover switch 23, and the control circuit 24 may form a wireless communication device.

The antenna 21A is connected to the changeover switch 23 through the power feeding line 22A. The antenna 21B is connected to the changeover switch 23 through the power feeding line 22B. The changeover switch 23 is connected to the control circuit 24.

The control circuit 24 controls the changeover switch 23 to switch between power supply to the power feeding line 22A and the antenna 21A and power supply to the power feeding line 22B and the antenna 21B. That is, the control circuit 24 controls the changeover switch 23 to switch between the use of the antenna 21A and the antenna 21B.

The control circuit 24 may transmit and receive information to and from each device mounted on the vehicle 2 via a controller area network (CAN) which is an example of in-vehicle communication and/or serial communication (for example, UART), and perform vehicle control.

The control circuit 24 may detect the state and switching of a knob switch 31 mounted on the vehicle 2. The control circuit 24 may control the display of an indicator 32 mounted on the vehicle 2. The control circuit 24 may control turning on, blinking, turning off and the like of a turn signal 33 mounted on the vehicle 2.

The electronic key 10 includes an antenna 11A, an antenna 11B, a power feeding line 12A, a power feeding line 12B, a changeover switch 13, a control circuit 14, and an operation button 15. The antenna 11A, the antenna 11B, the power feeding line 12A, the power feeding line 12B, the changeover switch 13, and the control circuit 14 may form a wireless communication device. The electronic key 10 may include only the antenna 11A, the power feeding line 12A, the control circuit 14, and the operation button 15.

The antenna 11A is connected to the changeover switch 13 through the power feeding line 12A. The antenna 11B is connected to the changeover switch 13 through the power feeding line 12B. The changeover switch 13 is connected to the control circuit 14.

The control circuit 14 controls the changeover switch 13 to switch between power supply to the power feeding line 12A and the antenna 11A and power supply to the power feeding line 12B and the antenna 11B. That is, the control circuit 14 controls the changeover switch 13 to switch between the use of the antenna 11A and the antenna 11B. The control circuit 14 detects an operation on the operation button 15.

The ECU 20 and the electronic key 10 can perform wireless communication through the antennas 21A, 21B, 11A, and 11B. The wireless communication method is Bluetooth (registered trademark). In this case, the control circuit 24 may be an IC chip for controlling Bluetooth wireless communication. Bluetooth may be either Bluetooth Low Energy or Bluetooth Classic. The wireless communication method is not limited to Bluetooth, but may be, for example, LTE, 4G, 5G, Wi-Fi (registered trademark), and the like.

Once the ECU 20 and the electronic key 10 are paired, within a communication range of both, a distance measurement start trigger is sent from the ECU 20 to the electronic key 10, and the distance measurement is performed at regular time intervals using the phase difference and RSSI of radio waves. The ECU 20 calculates the distance to the electronic key 10, and it is determined that the distance is within the predetermined distance, the user 1 turns the knob of the vehicle 2 to unlock the handlebar lock and turn on the ignition, and then press the engine start switch to start the engine.

At this time, the ECU 20 executes the instruction when the electronic key 10 is located within the predetermined distance, and does not execute the instruction when the electronic key 10 is located outside the predetermined distance. This is, for example, to prevent an unauthorized person who is not the owner of the vehicle 2 from transmitting an unauthorized wireless signal to the vehicle 2 from a remote location and attempting to unlock the vehicle 2. Therefore, the ECU 20 measures the distance to the electronic key 10 using wireless communication.

In the present embodiment, by mounting two antennas on each of the electronic key 10 and the ECU 20, a spatial diversity effect is obtained, and the occurrence of angles or frequency bands in which the distance cannot be measured with high accuracy is suppressed. The number of antennas mounted on each of the electronic key 10 and the ECU 20 is not limited to two, and may be three or more.

### <Method for Measuring Distance>

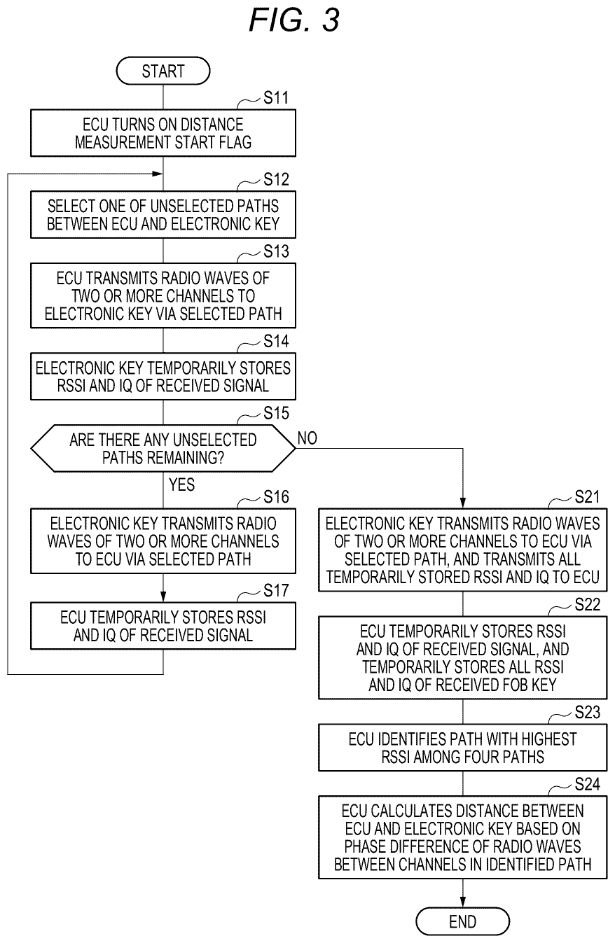

FIG. 3 is a flowchart showing an example of a method for measuring a distance between the ECU 20 and the electronic key 10 according to the first embodiment.

The control circuit 24 of the ECU 20 turns on a distance measurement start flag (S11).

The control circuit 24 of the ECU 20 selects one of unselected paths between the ECU 20 and the electronic key 10 (S12). For example, in the case of the configuration shown in FIG. 2, there are four paths: a communication path 41 between the antenna 21A and the antenna 11A; a communication path 42 between the antenna 21A and the antenna 11B; a communication path 43 between the antenna 21B and the antenna 11A; and a communication path 44 between the antenna 21B and the antenna 11B. In step S12, of these four paths 41, 42, 43, and 44, one path that has not yet been selected is selected. In the following description of FIG. 3, the path selected in step S12 is referred to as a selected path.

The control circuit 24 of the ECU 20 transmits radio waves of two or more channels to the electronic key 10 via the selected path (that is, from the antenna corresponding to the selected path) (S13). The radio waves of two or more channels refer to two or more radio waves having different frequencies.

The control circuit 14 of the electronic key 10 receives the radio wave transmitted from the ECU 20 in step S13 via the selected path (that is, the antenna corresponding to the selected path), and temporarily stores a received signal strength indicator (RSSI) and in-phase/quadrature-phase (IQ) of the received signal in a memory (not shown) (S14).

The control circuit 24 of the ECU 20 (or the control circuit 14 of the electronic key 10) determines whether all of the four paths 41, 42, 43, and 44 have been selected (S15).

First, a case where an unselected path remains among the four paths 41, 42, 43, and 44 (S15: YES) will be described.

The control circuit 14 of the electronic key 10 transmits radio waves of two or more channels to the ECU 20 via the selected path (that is, from the antenna corresponding to the selected path) (S16).

The control circuit 14 of the ECU 20 receives the radio wave transmitted from the electronic key 10 in step S16 via the selected path (that is, the antenna corresponding to the selected path), and temporarily stores the RSSI and the IQ of the received signal in a memory (not shown) (S17). Then, the process returns to step S12.

Next, a case where all of the four paths 41, 42, 43, and 44 have been selected (S15: NO) will be described.

The control circuit 14 of the electronic key 10 transmits radio waves of two or more channels to the ECU 20 via the last selected path (that is, from the antenna corresponding to the selected path), and transmits all the RSSI and IQ temporarily stored in the memory to the ECU 20 (S21).

The control circuit 24 of the ECU 20 receives the radio waves transmitted from the electronic key 10 and all the RSSI and IQ transmitted from the electronic key 10 in step S21 via the last selected path (that is, the antenna corresponding to the selected path), and temporarily stores all the RSSI and IQ in the memory (S22). As a result, the memory of the ECU 20 stores the RSSI and the IQ when the ECU 20 receives RSSI and IQ from the electronic key 10 and the RSSI and the IQ when the electronic key 10 receives RSSI and IQ from the ECU 20 for each of the four paths 41, 42, 43, 44.

The control circuit 24 of the ECU 20 identifies the path with the highest RSSI among the four paths 41, 42, 43, and 44 (S23). For example, the control circuit 24 of the ECU 20 calculates an average value (hereinafter referred to as an average RSSI) of the RSSI when the ECU 20 receives RSSI from the electronic key 10 and the RSSI when the electronic key 10 receives RSSI from the ECU 20 for each of the four paths 41, 42, 43, and 44, and identifies the path with the highest average RSSI.

The control circuit 24 of the ECU 20 calculates the distance between the ECU 20 and the electronic key 10 based on the phase difference of the radio waves between the channels in the path identified in step S23 (hereinafter referred to as an identified path) (S24). For example, the control circuit 24 of the ECU 20 calculates the distance according to the following steps (A1) to (A4). (A1) The control circuit 24 converts the IQ measured in the identified path into a phase. (A2) The control circuit 24 calculates a first phase by combining a phase obtained by converting the IQ of a first channel when the ECU 20 receives IQ from the electronic key 10 via the identified path and a phase obtained by converting the IQ of the first channel when the electronic key 10 receives IQ from the ECU 20 via the identified path. (A3) The control circuit 24 calculates a second phase by combining a phase obtained by converting the IQ of a second channel when the ECU 20 receives IQ from the electronic key 10 via the identified path and a phase obtained by converting the IQ of the second channel when the electronic key 10 receives IQ from the ECU 20 via the identified path. (A4) The control circuit 24 calculates a phase difference between the first phase and the second phase, and calculates the distance between the ECU 20 and the electronic key 10 based on the phase difference.

This allows the distance between the ECU 20 and the electronic key 10 to be calculated using the identified path with the best communication quality, making it possible to measure the distance with high accuracy.

### <Configuration of Substrate of ECU>

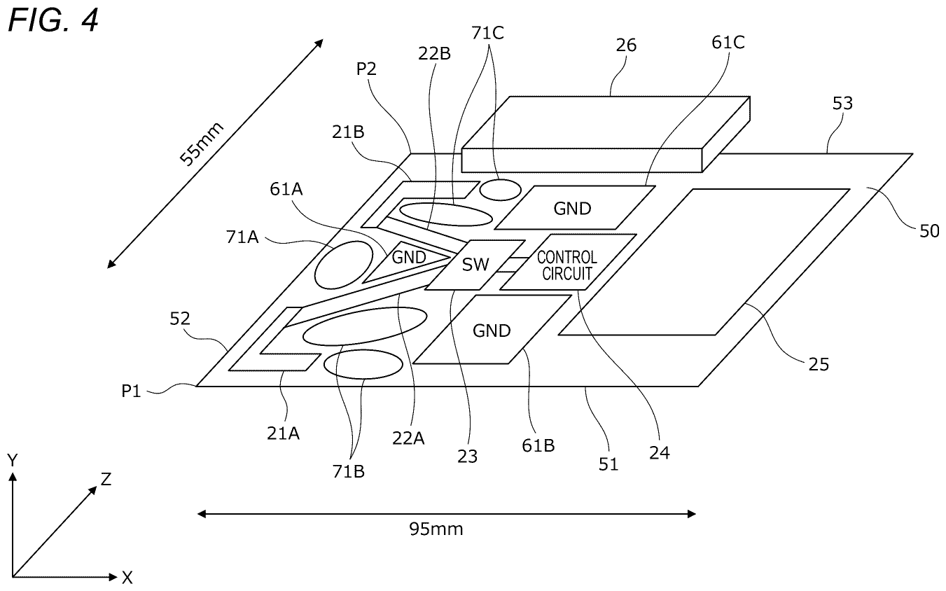

FIG. 4 is a perspective view showing a configuration example of a substrate 50 of the ECU 20 according to the first embodiment.

As shown in FIG. 4, the ECU 20 includes the substrate 50 having a substantially rectangular shape in plan view. On the substrate 50, the antenna 21A, the antenna 21B, the power feeding line 22A, the power feeding line 22B, the changeover switch 23, the control circuit 24, other circuits 25, and a connector 26 are arranged.

In the first embodiment, as shown in FIG. 4, an axis perpendicular to the surface of the substrate 50 is defined as a Y axis, and axes parallel to the surface of the substrate 50 are defined as an X axis and a Z axis. The X axis is parallel to a first side 51 of the substrate 50, and the Z axis is parallel to a second side 52 of the substrate 50. For convenience of description, a positive direction of the Y axis may be referred to as “upper”, and a negative direction of the Y axis may be referred to as “lower”. The expressions related to these directions are used for convenience of explanation, and are not intended to limit a posture of the structure in actual use.

The antenna 21A is arranged in an L shape in the vicinity of a vertex P1 on a first end side of the second side 52 of the substrate 50. The antenna 21B is arranged in an L shape in the vicinity of a vertex P2 on a second end side of the second side 52 of the substrate 50. The antenna 21A and the antenna 21B may be arranged in a manner other than the L-shape. The antennas 21A and 21B are monopole antennas. The antennas 21A and 21B may be inverted-F antennas or patch antennas (or microstrip antennas).

The changeover switch 23 is disposed near the center of the substrate 50.

The power feeding line 22A is disposed so as to electrically connect an end of the L-shaped antenna 21A and the changeover switch 23. The power feeding line 22B is disposed so as to electrically connect an end of the L-shaped antenna 21B and the changeover switch 23. An angle formed by a straight line that is an imaginary extension of the power feeding line 22A and a straight line that is an imaginary extension of the power feeding line 22B may be about 90 degrees.

A GND 61A for ensuring isolation between the power feeding lines is disposed in an angular gap formed by the power feeding line 22A and the power feeding line 22B.

The antenna 21A and the antenna 21B are spaced apart by a predetermined distance or more (for example, 30 mm or more). This is to obtain a spatial diversity effect. The distance between the antenna 21A and the antenna 21B may be less than 30 mm.

A GND hole 71A is formed in a space surrounded by the antenna 11A, the antenna 21B, and the GND 61A.

This configuration can suppress occurrence of interference of radio waves and noise between the antenna 21A and the power feeding line 22A and between the antenna 21B and the power feeding line 22B.

The control circuit 24 is disposed adjacent to the changeover switch 23 on a positive direction side of the X axis, and is electrically connected to the changeover switch 23.

An IC GND 61B is disposed adjacent to the control circuit 24 on a negative direction side of the Z axis. An IC GND 61C is disposed adjacent to the control circuit 24 on a positive direction side of the Z axis.

A GND hole 71B is formed in a space surrounded by the IC GND 61B, the power feeding line 22A, and the antenna 21A. A GND hole 71C is formed in a space surrounded by the IC GND 61C, the power feeding line 22B, and the antenna 21B.

The other circuits 25 is disposed adjacent to the control circuit 24 on the positive direction side of the X-axis, for example.

The connector 26 is disposed, for example, near a third side 53 opposite the first side 51 of the substrate 50.

When the components and the GND are disposed on the substrate 50 as shown in FIG. 4, the components and the GND can be arranged on the substrate 50 having the first side 51 of 95 mm and the second side 52 of 55 mm, for example, as shown in FIG. 4. The substrate 50 may be of any size.

The arrangement of the antennas 21A and 21B and the power feeding lines 22A and 22B and the like shown in FIG. 4 may be applied to a substrate of the electronic key 10.

### <Antenna Directivity Graph>

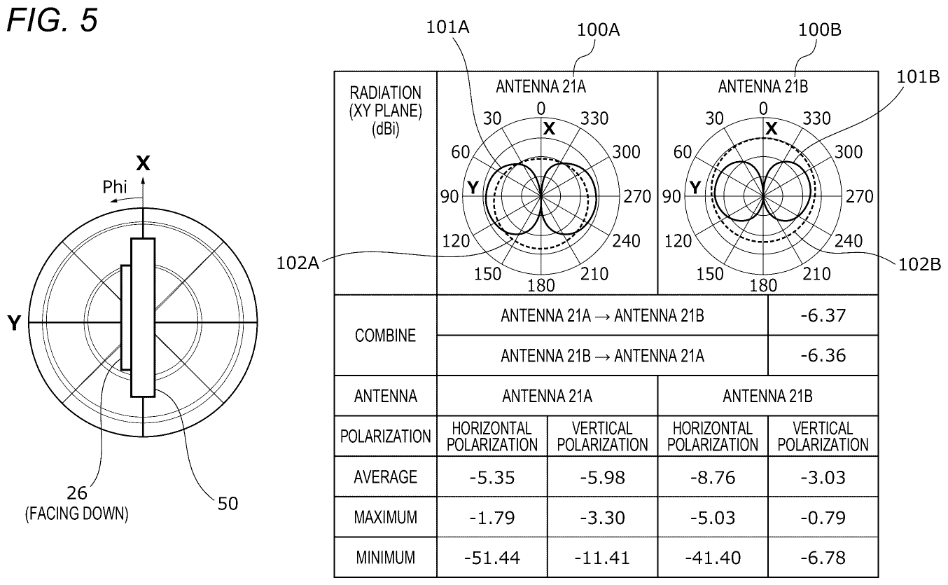

FIG. 5 is a graph showing an example of antenna directivity of the antenna 21A and the antenna 21B according to the first embodiment.

Graph 100A of FIG. 5 shows the 360-degree antenna directivity of the antenna 21A in an XY plane. In Graph 100A, a solid line 101A indicates the gain for horizontal polarization, and a dotted line 102A indicates the gain for vertical polarization.

Graph 100B of FIG. 5 shows the 360-degree antenna directivity of the antenna 21B in the XY plane. In Graph 100B, a solid line 101B indicates the gain for horizontal polarization, and a dotted line 102B indicates the gain for vertical polarization.

When the antennas 21A and 21B and the power feeding lines 22A and 22B and the like are arranged as shown in FIG. 4, radio waves can be transmitted and received in all directions, approximately 360 degrees, as shown in Graphs 100A and 100B. That is, there are no angles or frequency bands in which the distance cannot be measured with high accuracy. Therefore, regardless of the direction in which the electronic key 10 is positioned relative to the vehicle 2, the ECU 20 can accurately measure the distance to the electronic key 10.

### Second Embodiment

In the second embodiment, the size of the substrate 50 can be made smaller than that of the first embodiment, and the configuration of the ECU 20 (wireless communication device) having the same performance as that of the first embodiment with respect to 360-degree antenna directivity will be described. In the second embodiment, the description of the contents common to the first embodiment, such as the method for measuring distance, may be omitted.

### <Configuration of Substrate of ECU>

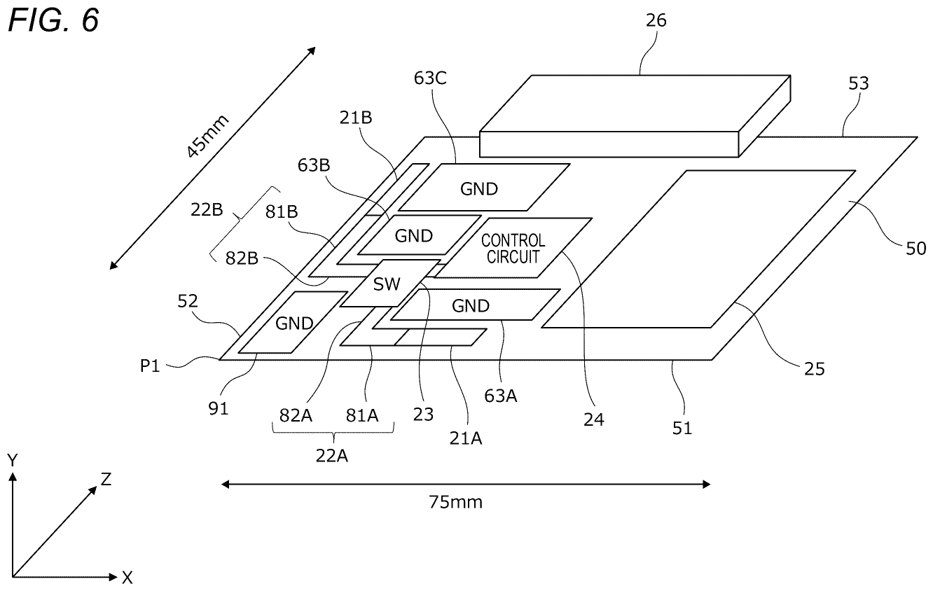

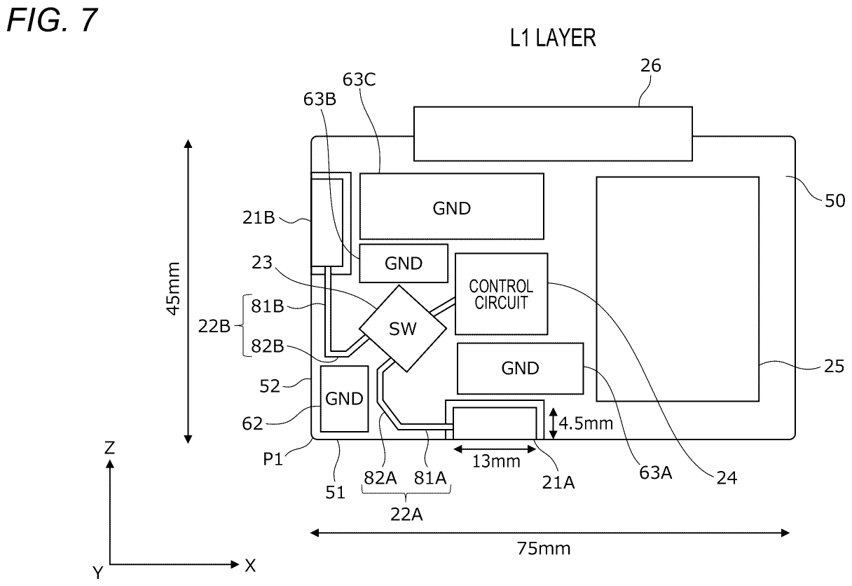

FIG. 6 is a perspective view showing a configuration example of a first layer of the substrate 50 of the ECU 20 according to the second embodiment. FIG. 7 is a plan view showing a configuration example of the first layer (L1 layer) of the substrate 50 of the ECU 20 according to the second embodiment. As shown in FIG. 7 and FIGS. 8 to 10 to be described later, the substrate 50 has a laminated configuration (that is, a multilayer substrate) of the first layer (L1 layer), a second layer (L2 layer), a third layer (L3 layer), and a fourth layer (L4 layer).

As shown in FIGS. 6 and 7, the ECU 20 includes the substrate 50 having a substantially rectangular shape in plan view. On the substrate 50, the antenna 21A, the antenna 21B, the power feeding line 22A, the power feeding line 22B, the changeover switch 23, the control circuit 24, other circuits 25, and a connector 26 are arranged.

In the second embodiment, as shown in FIGS. 6 and 7, the axis perpendicular to the surface of the substrate 50 is defined as the Y axis, and the axes parallel to the surface of the substrate 50 are defined as the X axis and the Z axis. The X axis is parallel to the first side 51 of the substrate 50, and the Z axis is parallel to the second side 52 of the substrate 50. For convenience of description, the positive direction of the Y axis may be referred to as “upper”, and the negative direction of the Y axis may be referred to as “lower”. The expressions related to these directions are used for convenience of explanation, and are not intended to limit a posture of the structure in actual use.

The antenna 21A is disposed in an I-shape along the first side 51 at a position a predetermined distance away from the apex PI of the substrate 50 along the first side 51. The antenna 21B is disposed in an I-shape along the second side 52 at a position a predetermined distance away from the apex Pl of the substrate 50 along the second side 52.

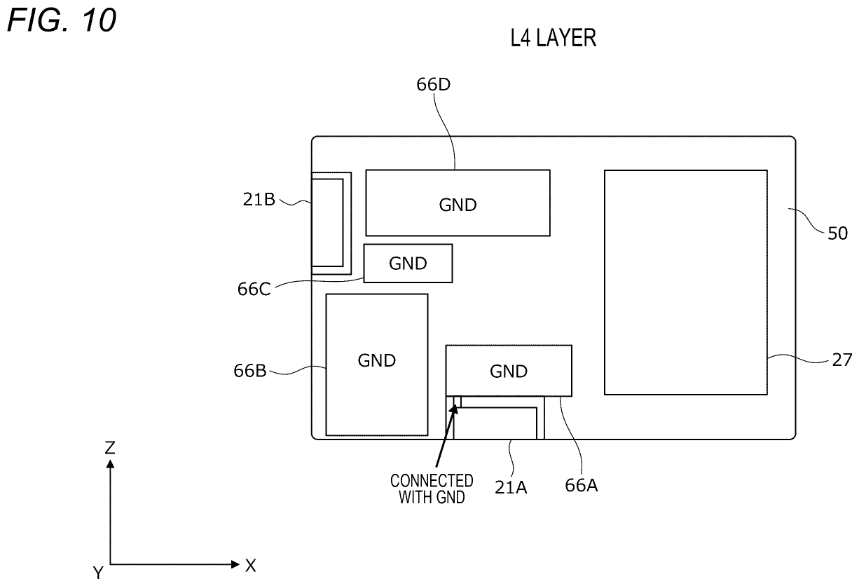

The antennas 21A and 21B are patch antennas (or microstrip antennas). The antennas 21A and 21B may be monopole antennas or inverted F antennas. When the antennas 21A and 21B are monopole antennas, they are folded back at a predetermined position and connected to GND as shown in FIG. 10.

The antenna 21A and the antenna 21B are spaced apart by a predetermined distance or more (for example, 30 mm or more). This is to obtain a spatial diversity effect. The distance between the antenna 21A and the antenna 21B may be less than 30 mm.

The changeover switch 23 is disposed at a position a predetermined distance away from the apex P1 of the substrate 50 toward the center of the substrate 50.

The power feeding line 22A is disposed so as to electrically connect an end of the antenna 21A and the changeover switch 23 in an L-shape. A portion of the L-shaped power feeding line 22A extending from the antenna 21A along the first side 51 is referred to as a power feeding line portion 81A, and a portion of the L-shaped power feeding line 22A extending from the changeover switch 23 along the second side 52 is referred to as a power feeding line portion 82A.

The power feeding line 22B is disposed so as to electrically connect an end of the antenna 21B and the changeover switch 23 in an L-shape. A portion of the L-shaped power feeding line 22B extending from the antenna 21B along the second side 52 is referred to as a power feeding line portion 81B, and a portion of the L-shaped power feeding line 22B extending from the changeover switch 23 along the first side 51 is referred to as a power feeding line portion 82B.

An angle formed by a straight line that is an imaginary extension of a longitudinal direction of the antenna 21A and a straight line that is an imaginary extension of a longitudinal direction of the antenna 21B may be about 90 degrees. Further, an angle formed by a straight line that is an imaginary extension of the power feeding line portion 81A and a straight line that is an imaginary extension of the power feeding line portion 81B may be about 90 degrees.

A GND 62 for ensuring isolation between the power feeding lines is disposed in a space surrounded by the vertex P1 of the substrate 50, the changeover switch 23, the power feeding line 22A, and the power feeding line 22B.

The control circuit 24 is disposed near the center of the substrate 50 and is electrically connected to the changeover switch 23.

An IC GND 63A is disposed between the control circuit 24 and the antenna 21A. An IC GND 63B is disposed between the control circuit 24 and the power feeding line portion 81B. An IC GND 63C is disposed adjacent to the control circuit 24 on the positive direction side of the Z axis. Since the antennas 21A and 21B are patch antennas, they are less susceptible to the influence of the surrounding GNDs, which allows the components and GNDs to be disposed around the antennas 21A and 21B in this manner. The number, size, and arrangement positions of the IC GNDs shown in FIG. 6 are merely examples, and are not limited thereto.

The other circuits 25 is disposed adjacent to the control circuit 24 on the positive direction side of the X-axis, for example.

The connector 26 is disposed, for example, near a third side 53 opposite the first side 51 of the substrate 50.

As shown in FIG. 7, the sizes of the antennas 21A and 21B are, for example, 13 mm the long side and 4.5 mm on the short side. The sizes of the antennas 21A and 21B are not limited thereto.

As shown in FIG. 7, in the first layer of the substrate 50, portions where the antennas 21A and 21B are to be disposed are hollowed out.

When the components and the GND are disposed on the substrate 50 as shown in FIGS. 6 and 7, the components and the GND can be arranged on the substrate 50 having the first side 51 of 75 mm and the second side 52 of 45 mm, for example, as shown in FIGS. 6 and 7. That is, according to the arrangement method of the components and the GND shown in FIGS. 6 and 7, the size of the substrate 50 and the ECU 20 can be reduced as compared with the arrangement method of the components and the GND shown in FIG. 4 according to the first embodiment.

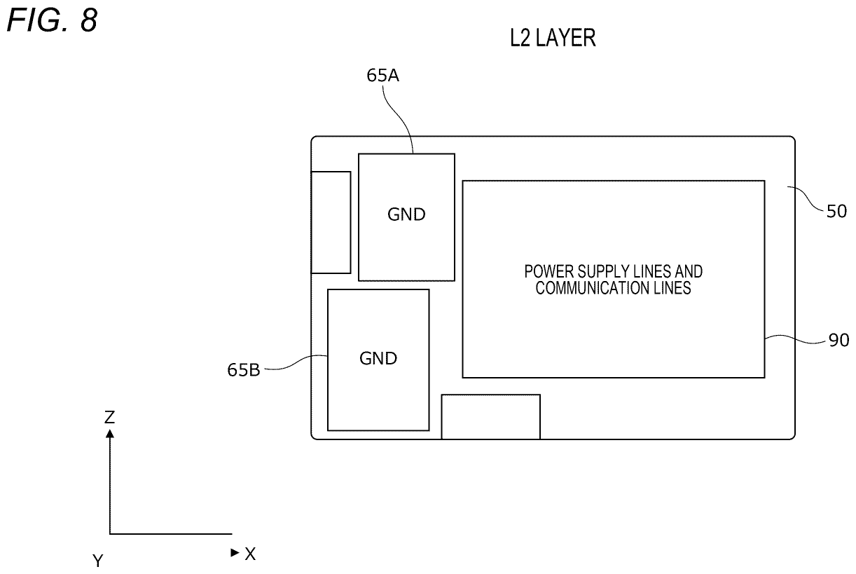

FIG. 8 is a plan view showing a configuration example of the second layer (L2 layer) of the substrate 50 of the ECU 20 according to the second embodiment.

As shown in FIG. 8, in the second layer of the substrate 50, portions where the antennas 21A and 21B are to be disposed are hollowed out.

In the second layer of the substrate 50, power supply lines and communication lines 90 are disposed in a region where the control circuit 24 and the other circuits 25 and 27 of the other layers (see FIG. 10) are arranged. Power supply and data transmission and reception to and from the control circuit 24 and the other circuits 25 and 27 of the other layers are performed through the power supply lines and communication lines 90 of the second layer.

In the second layer of the substrate 50, an IC GND 65A is disposed adjacent to the power supply lines and communication lines 90 on the negative direction side of the X axis. In the second layer of the substrate 50, a GND 65B is disposed in a space between the antenna 21A and the antenna 21B.

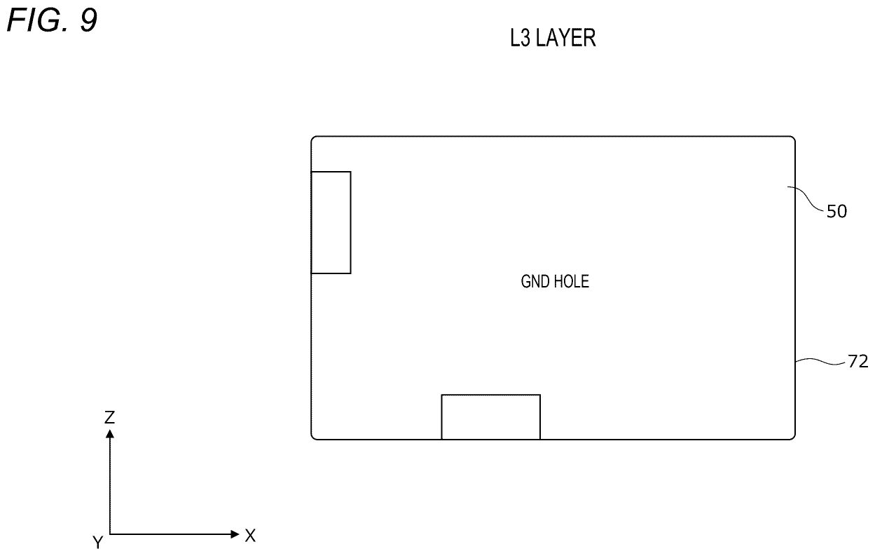

FIG. 9 is a plan view showing a configuration example of the third layer (L3 layer) of the substrate 50 of the ECU 20 according to the second embodiment.

As shown in FIG. 9, in the third layer of the substrate 50, portions where the antennas 21A and 21B are to be disposed are hollowed out. The third layer of the substrate 50 is provided with a GND hole 72.

FIG. 10 is a plan view showing a configuration example of the fourth layer (L4 layer) of the substrate 50 of the ECU 20 according to the second embodiment.

In the fourth layer of the substrate 50, the other circuits 27 is disposed in substantially the same region as the other circuits 25 of the first layer.

As shown in FIG. 10, in the fourth layer of the substrate 50, portions where the antennas 21A and 21B are to be disposed are hollowed out.

The antennas 21A and 21B are patch antennas having a predetermined height (thickness), and are disposed in the hollowed-out portions of the fourth layer, the third layer, the second layer, and the first layer of the substrate 50.

A GND 66A is arranged adjacent to the antenna 21A on the positive direction side of the Z axis. The antenna 21A is connected to the GND 66A.

A GND 66B is disposed in a space between the antenna 21A and the antenna 21B. An IC GND 66C and an IC GND 66D are arranged adjacent to the antenna 21B on the positive direction side of the X axis.

The arrangement of the antennas 21A and 21B and the power feeding lines 22A and 22B and the like shown in FIGS. 8 to 10 may be applied to a substrate of the electronic key 10.

### <Antenna Directivity Graph>

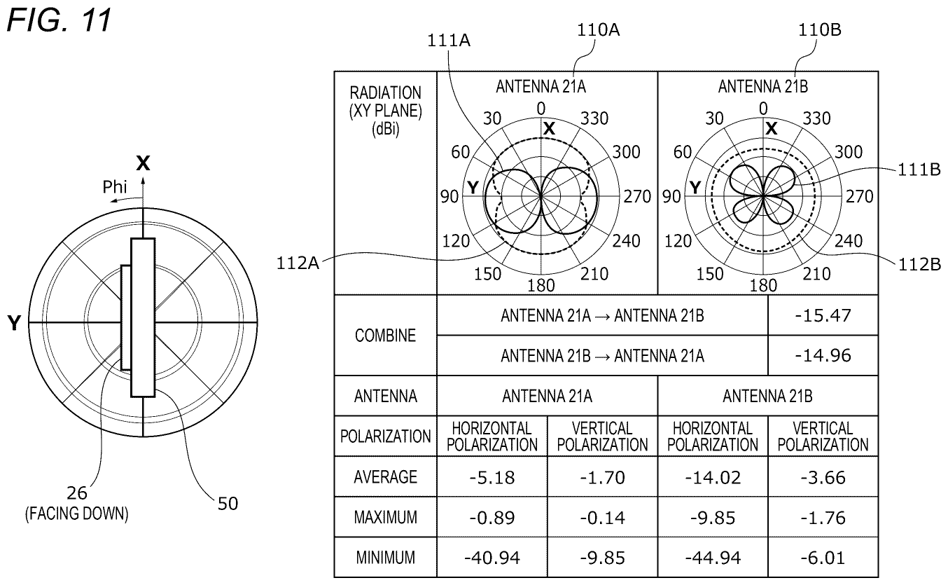

FIG. 11 is a graph showing an example of antenna directivity of the antenna 21A and the antenna 21B according to the second embodiment.

Graph 110A of FIG. 11 shows the 360-degree antenna directivity of the antenna 21A in the XY plane. In Graph 110A, a solid line 111A indicates the gain for horizontal polarization, and a dotted line 112A indicates the gain for vertical polarization.

Graph 110B of FIG. 11 shows the 360-degree antenna directivity of the antenna 21B in the XY plane. In Graph 110B, a solid line 111B indicates the gain for horizontal polarization, and a dotted line 112B indicates the gain for vertical polarization.

When the antennas 21A and 21B and the power feeding lines 22A and 22B and the like are arranged as shown in FIGS. 6 to 10, radio waves can be transmitted and received in all directions, approximately 360 degrees, as shown in Graphs 110A and 110B. That is, there are no angles or frequency bands in which the distance cannot be measured with high accuracy. Therefore, regardless of the direction in which the electronic key 10 is positioned relative to the vehicle 2, the ECU 20 can accurately measure the distance to the electronic key 10. In addition, Graphs 110A and 110B shown in FIG. 11 show no degradation in wireless communication characteristics when compared with Graphs 100A and 100B shown in FIG. 5 according to the first embodiment.

Therefore, according to the configuration shown in FIG. 6 to FIG. 10 of the second embodiment, the size of the substrate 50 (the size of the ECU 20) can be reduced without deteriorating the characteristics of the wireless communication compared to the configuration shown in FIG. 4 according to the first embodiment.

### Summary of Present Disclosure

The following techniques are disclosed from the above description of the second embodiment.

### <Technique 1>

A wireless communication device (for example, the ECU 20) that is mounted on a vehicle (2) to perform wireless communication with an electronic key (10) of the vehicle, the wireless communication device includes: a substrate (50) having a rectangular shape in a plan view; a first antenna (21A) disposed at a position along a first side (51) of the substrate at a predetermined distance away from one vertex (P1) of the substrate and extending along the first side; a second antenna (21B) disposed at a position along a second side (52) of the substrate, which is different from the first side of the substrate, at a predetermined distance away from the vertex of the substrate and extending along the second side; and a first GND (62) disposed near the vertex of the substrate.

Accordingly, the size of the substrate can be reduced while suppressing interference between the first antenna and the second antenna.

### <Technique 2>

The wireless communication device according to Technique 1 further includes: a first power feeding line (22A) including a first power feeding line portion (81A) extending from the first antenna (21A) toward the vertex (P1) along the first side (51); a second power feeding line (22B) including a second power feeding line portion (81B) extending from the second antenna (21B) toward the vertex along the second side (52); and a changeover switch (23) to which the first power feeding line and the second power feeding line are connected, in which the first GND (62) is disposed in a region surrounded by the changeover switch, the first power feeding line, the second power feeding line, and the vertex.

Accordingly, the size of the substrate can be reduced while suppressing interference between the first antenna and the first power feeding line and between the second antenna and the second power feeding line.

### <Technique 3>

In the wireless communication device according to Technique 2, an angle formed by a straight line that is an imaginary extension of the first power feeding line portion and a straight line that is an imaginary extension of the second power feeding line portion is 90 degrees.

Accordingly, interference between the first power feeding line and the second power feeding line can be suppressed.

### <Technique 4>

In the wireless communication device according to any one of Techniques 1 to 3, the first antenna and the second antenna are patch antennas.

Accordingly, the size of the antennas can be reduced, and therefore the size of the substrate can be reduced.

### <Technique 5>

The wireless communication device according to any one of Techniques 1 to 4 further includes: a control circuit (24) to which the changeover switch is connected, in which the control circuit controls the changeover switch to switch between use of the first antenna and use of the second antenna.

Accordingly, the control circuit can switch between the use of the first antenna and the use of the second antenna to perform wireless communication with the electronic key, and detect a path with high communication quality.

### <Technique 6>

The wireless communication device according to Technique 5 further includes: a second GND (63A) disposed between the control circuit and the first antenna on the substrate; and a third GND (63B) disposed between the control circuit and the second antenna on the substrate.

Since the first antenna and the second antenna are patch antennas, they are less susceptible to the influence of the surrounding GNDs. Therefore, the second GND can be disposed near the first antenna, and the third GND can be disposed near the second antenna. As a result, the size of the substrate can be reduced.

### <Technique 7>

In the wireless communication device according to any one of Techniques 1 to 6, the first antenna and the second antenna are separated by a predetermined distance or more.

As a result, the spatial diversity effect can be obtained, and it is possible to reduce occurrence of a frequency or an angle at which wireless communication with the electronic key is deteriorated.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

### INDUSTRIAL APPLICABILITY

The technique of the present disclosure is useful for a wireless communication device mounted on a vehicle.

### CROSS-REFERENCE TO RELATED APPLICATIONS

This application is based on and claims priority under 35 USC 119 from Japanese Patent Application No. 2024-041446 filed on Mar. 15, 2024, the contents of which are incorporated herein by reference.

What is claimed is:

1. A wireless communication device that is mounted on a vehicle to perform wireless communication with an electronic key of the vehicle, the wireless communication device comprising:
a substrate having a rectangular shape in a plan view;
a first antenna disposed at a position along a first side of the substrate at a predetermined distance away from one vertex of the substrate and extending along the first side;
a second antenna disposed at a position along a second side of the substrate, which is different from the first side of the substrate, at a predetermined distance away from the vertex of the substrate and extending along the second side; and
a first GND disposed near the vertex of the substrate.

2. The wireless communication device according to claim 1, further comprising:
a first power feeding line including a first power feeding line portion extending from the first antenna toward the vertex along the first side;
a second power feeding line including a second power feeding line portion extending from the second antenna toward the vertex along the second side; and
a changeover switch to which the first power feeding line and the second power feeding line are connected,
wherein the first GND is disposed in a region surrounded by the changeover switch, the first power feeding line, the second power feeding line, and the vertex.

3. The wireless communication device according to claim 2,
wherein an angle formed by a straight line that is an imaginary extension of the first power feeding line portion and a straight line that is an imaginary extension of the second power feeding line portion is 90 degrees.

4. The wireless communication device according to claim 2,
wherein the first antenna and the second antenna are patch antennas.

5. The wireless communication device according to claim 4, further comprising:
a control circuit to which the changeover switch is connected,
wherein the control circuit controls the changeover switch to switch between use of the first antenna and use of the second antenna.

6. The wireless communication device according to claim 5, further comprising:
a second GND disposed between the control circuit and the first antenna on the substrate; and
a third GND disposed between the control circuit and the second antenna on the substrate.

7. The wireless communication device according to claim 1,
wherein the first antenna and the second antenna are separated by a predetermined distance or more.
